(19) United States
(12) Patent Application Publication
(10) Pub. No.: US 2012/0188622 A1
(43) Pub. Date: Jul. 26, 2012

(54) HOLOGRAM RECORDING APPARATUS

(75) Inventor: Shin YASUDA, Kanagawa (JP)

(73) Assignee: FUJI XEROX CO., LTD., Tokyo (JP)

(21) Appl. No.: 13/209,908

(22) Filed: Aug. 15, 2011

(30) Foreign Application Priority Data
Jan. 21, 2011 (JP) 2011-010510

(51) Int. Cl. G03H 1/26

(52) U.S. Cl. 359/23

(57) ABSTRACT

A hologram recording apparatus includes a reference light applying unit that includes an incidence plane, that converts reference light to be incident on the incidence plane into reference beams incident on a recording medium from plural directions, and that simultaneously applies the reference beams to the recording medium, and an object light applying unit that applies object light, in which plural identical parallax images are arranged to correspond to the neighboring reference beams having different incidence angles, to the recording medium.

### CROSS-REFERENCE TO RELATED APPLICATIONS

This application is based on and claims priority under 35 USC 119 from Japanese Patent Application No. 2011-010510 filed Jan. 21, 2011.

### BACKGROUND

(i) Technical Field

The present invention relates to a hologram recording apparatus.

(ii) Related Art

Studies have been carried out in regard to holographic stereogram technology which has the features that it is not necessary to directly illuminate a subject to be displayed with laser light, that an image is not limited to a visible ray image, and that a fictional object is able to be stereoscopically displayed.

In a holographic stereogram, plural parallax images constituting an image to be created are recorded on a recording medium one by one. At this time, the parallax images are recorded as strip-like element holograms on the recording medium and a three-dimensional image is formed by recording these strip-like element holograms on the recording medium in parallel.

At the time of reproducing a hologram, a three-dimensional image is reproduced using the same illuminating light as the reference light used at the time of recording.

### SUMMARY

According to an aspect of the invention, there is provided a hologram recording apparatus including: a reference light applying unit that includes an incidence plane, that converts reference light incident on the incidence plane into reference beams to be incident on a recording medium from plural directions, and that simultaneously applies the reference beams to the recording medium; and an object light applying unit that applies object light, in which plural identical parallax images are arranged to correspond to the neighboring reference beams having different incidence angles, to the recording medium.

### BRIEF DESCRIPTION OF THE DRAWINGS

Exemplary embodiments of the present invention will be described in detail based on the following figures, wherein:

FIGS. 1A and 1B are diagrams illustrating an example of an image of which a hologram should be created;

FIGS. 2A, 28, and 2C are top views illustrating a configuration example of a hologram recording apparatus according to a first exemplary embodiment of the invention;

FIGS. 3A and 3B are top views illustrating the configuration of a hologram recording apparatus according to a second exemplary embodiment of the invention; and

FIGS. 4A and 4B are diagrams illustrating an example of an optical element array used in a hologram recording apparatus according to a third exemplary embodiment of the invention.

### DETAILED DESCRIPTION

Hereinafter, exemplary embodiments of the invention will be described with reference to the accompanying drawings.

### First Exemplary Embodiment

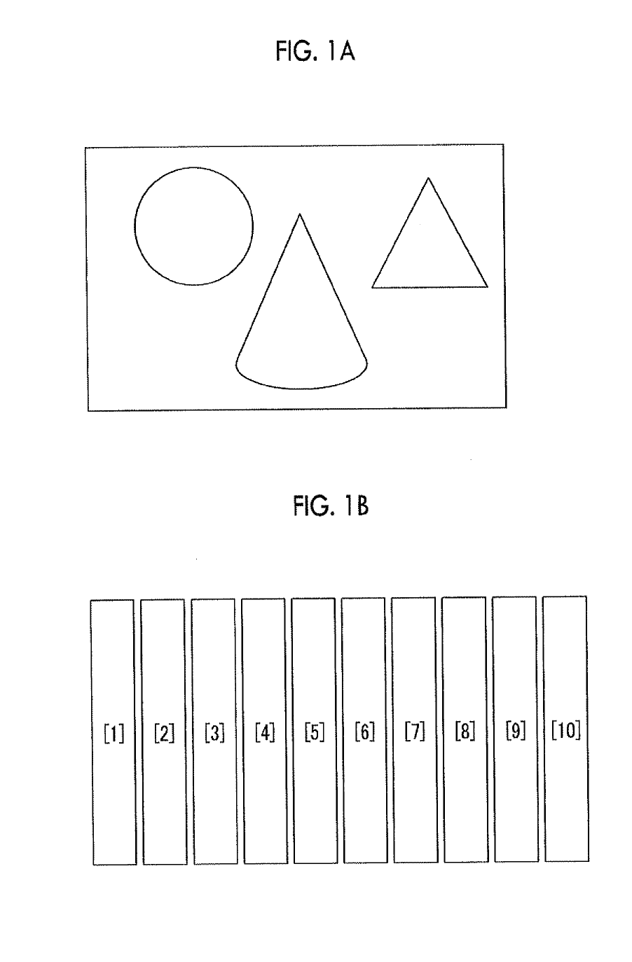

In a first exemplary embodiment of the invention, it is assumed that an image shown in FIG. 1A is recorded as a hologram. In the first exemplary embodiment, parallax images [1] to [10] constituting a parallax image sequence are recorded on a hologram recording medium in parallel in a parallax direction, as shown in FIG. 1B. Accordingly, a three-dimensional image of the image shown in FIG. 1A is formed. In this specification, the direction in which the parallax images are arranged is described as a “parallax direction”.

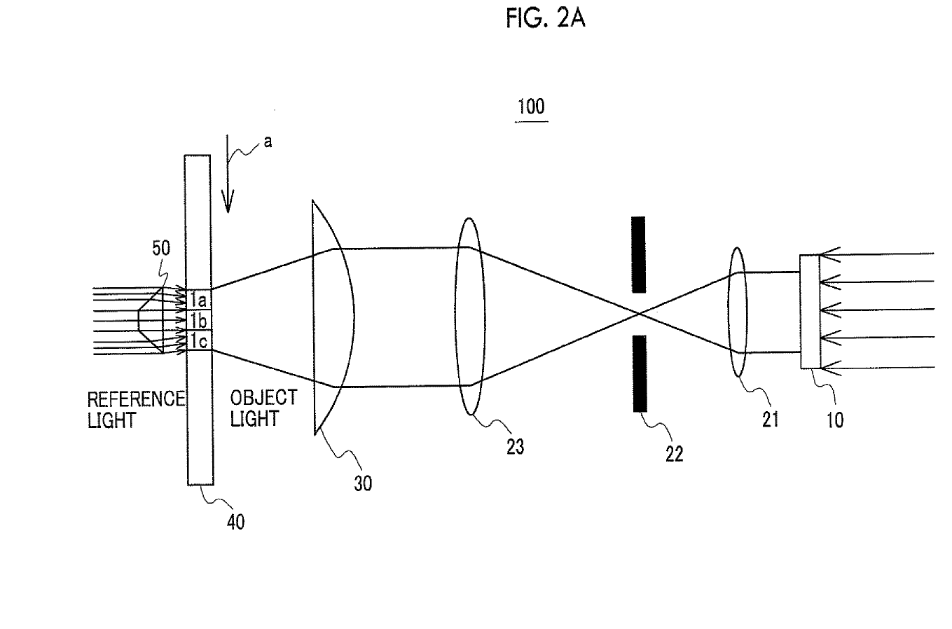

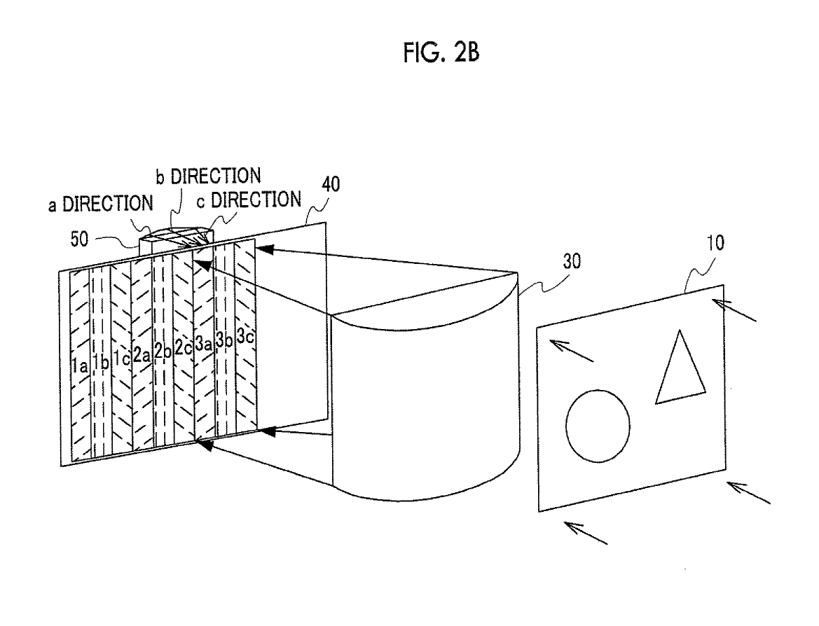

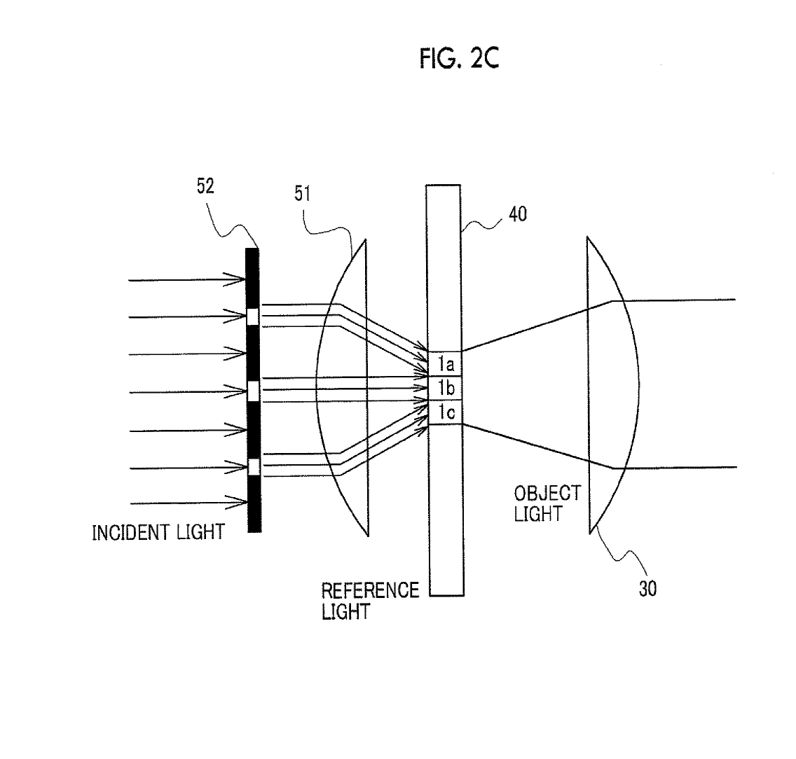

FIGS. 2A, 2B, and 2C are top views illustrating a configuration example of a hologram recording apparatus according to the first exemplary embodiment of the invention. The hologram recording apparatus 100 includes a spatial light modulator 10. The spatial light modulator 10 is formed of, for example, a liquid crystal panel and modulates the intensity of light incident on the spatial light modulator 10 on the basis of the gray scales of the parallax images (typically multi-valued images) to be displayed. The light generated by causing the spatial light modulator 10 to modulate the intensity thereof serves as object light.

The object light generated by the spatial light modulator 10 is condensed by a lens 21, a high-order diffraction component due to the pixel pitch of the spatial light modulator 10 is removed therefrom by a filter 22, the resultant light is converted into parallel light by a lens 23, and the parallel light is incident on a cylindrical lens 30.

The object light incident on the cylindrical lens 30 is condensed on a hologram recording medium 40 by the cylindrical lens 30.

The hologram recording apparatus 100 includes an optical element 50 on a side opposed to the object light with the hologram recording medium 40 interposed therebetween. The optical element 50 is an example of the reference light applying unit. Laser light emitted from a laser source not shown is incident as the reference light on the optical element 50.

The optical element 50 changes an exit angle of the reference light exiting from an exit plane of the optical element 50 depending on the incidence position of the reference light, and applies the changed reference light to the hologram recording medium 40. Specifically, the optical element 50 converts the incident reference light into reference light including plural light beams having different optical axes and applies the resultant reference light to the hologram recording medium 40. Accordingly, the reference light is simultaneously applied to the hologram recording medium 40 from plural directions.

The object light condensed on the hologram recording medium 40 by the cylindrical lens 30 interferes with the reference light applied to the hologram recording medium 40 from plural directions, and interference fringes are recorded on the hologram recording medium 40. Accordingly, the parallax images represented by the object light are simultaneously recorded on the hologram recording medium 40 in the incidence directions of the reference light.

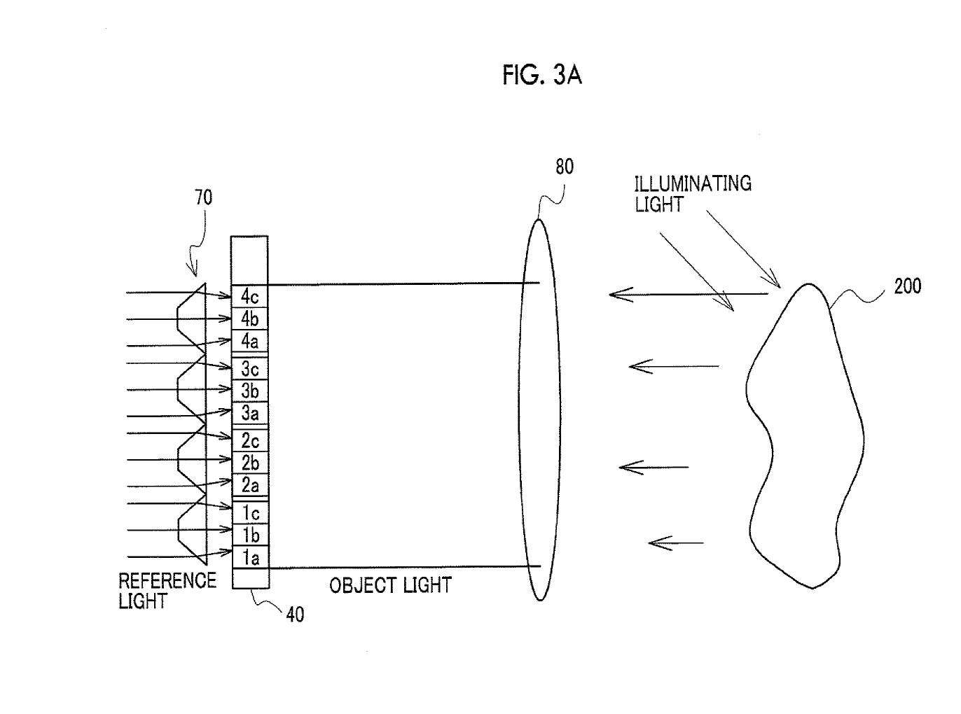

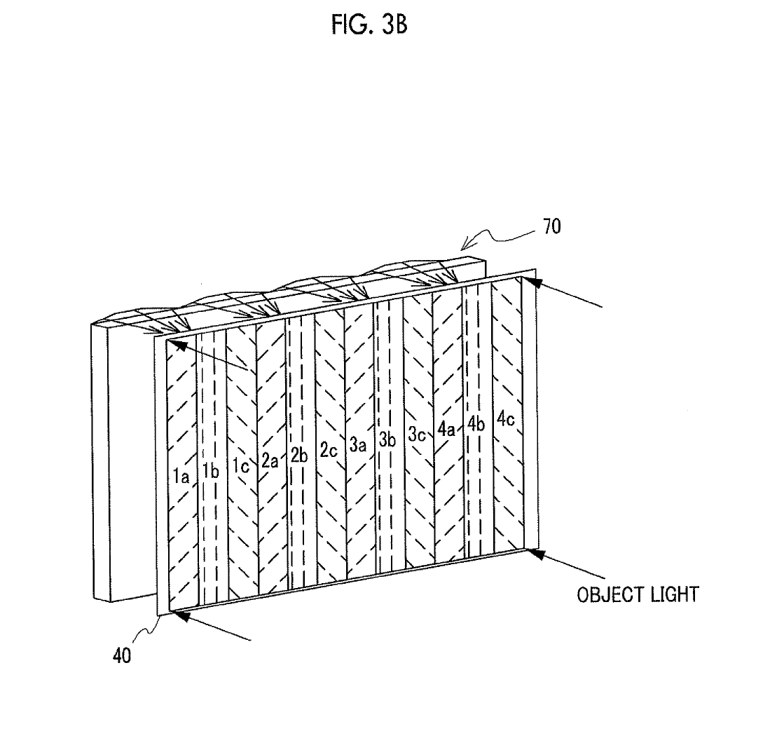

FIG. 2B is a perspective view illustrating an example when an element hologram of parallax image [3] included in the parallax image sequence shown in FIG. 1B is recorded on the hologram recording medium 40. As shown in FIG. 2B, the reference light incident on the optical element 50 is converted into the reference light, which is simultaneously applied to the hologram recording medium 40 from an a direction, a b direction, and a c direction, by the optical element. Parallax images [3] are recorded on the hologram recording medium 40 simultaneously in the incidence directions of the reference light. Specifically, as shown in FIG. 3B, parallax image [3] (referred to as element hologram 3a) recorded using the reference beam applied in the a direction, parallax image [3] (referred to as element hologram 3b) recorded using the reference beam applied in the b direction, and parallax image [3] (referred to as element hologram 3c) recorded using the reference beam applied in the c direction are simultaneously recorded on the hologram recording medium 40. The element holograms 3a, 3b, and 3c hold the same parallax image.

When it is intended to apply the reference light to the hologram recording medium from plural directions, a method of changing the incidence directions of the reference light applied to the hologram recording medium by moving an optical system generating the reference light is considered (for example, see JP-A-2001-350395). However, in this method, the optical system generating the reference light is moved and thus the size of the apparatus increases. Since the reference light may not be simultaneously applied from plural directions, one element hologram should be recorded for each reference beam incident from each direction.

On the other hand, in the hologram recording apparatus according to this exemplary embodiment, the optical element 50 converts the reference light incident on the optical element 50 into the reference light to be incident on the recording medium from plural directions with respect to the parallax direction and applies the reference light to the hologram recording medium 40. Accordingly, the reference light is simultaneously applied from plural directions to create a hologram. Since the respective parallax images are recorded on the hologram recording medium 40 depending on the incidence directions of the reference light, a stereoscopic image is reproduced by bringing the same illuminating beam as any beam of the reference light used to record the parallax images into contact with the hologram. For example, when a hologram is created as shown in FIGS. 2A to 2C and the same illuminating beam as the reference beam applied from at least one direction of the a direction, the b direction, and the c direction comes in contact with the hologram, a stereoscopic image is reproduced. Accordingly, in the hologram created by the hologram recording apparatus according to the first exemplary embodiment, the conditions regarding the illuminating beam for reproducing the hologram are alleviated.

Since the reference light is simultaneously applied to the hologram recording medium from plural directions, the parallax images in the incidence directions of the reference light are simultaneously recorded on the hologram recording medium. Specifically, for example, the element holograms 3a to 3c of parallax image [3] are simultaneously recorded on the hologram recording medium 40. Accordingly, it is possible to shorten the hologram creation time.

Therefore, according to the first exemplary embodiment, it is possible to shorten the hologram creation time and to create a hologram which alleviates the conditions regarding an illuminating beam for reproducing the hologram.

In this exemplary embodiment, the total width of the same parallax images is preferably equal to or less than a pupil diameter (equal to or less than about 3 mm). Specifically, the total width of the element holograms 3a to 3c is preferably equal to or less than pupil diameter. That is, the width of the parallax image recorded in one incidence direction may be equal or less than (pupil diameter/the number of incidence directions of reference light used to record parallax images). In this exemplary embodiment, since the number of incidence directions of the reference light is 3, the width of an element image recorded in one incidence direction is preferably equal to or less than a third of the pupil diameter (about 1 mm). By setting the total width of the parallax images recorded in the incidence directions of the reference light to be equal to or less than the pupil diameter, it is possible to suppress the reproduced stereoscopic image from giving a sense of discontinuity to an observer. When it is intended to set the total width of the same parallax images to be equal to or less than the pupil diameter (equal to or less than about 3 mm), the width of the optical element 50 in the parallax direction may be set to be equal to or less than the pupil diameter.

As shown in FIG. 2C, a spatial light modulator 52 and a cylindrical lens 51 may be combined and used as the reference light applying unit instead of the optical element 50 shown in FIG. 2A. In FIG. 2C, laser light emitted from a laser source not shown is incident on the spatial light modulator 52 as reference light. The spatial light modulator 52 transmits the reference light through plural apertures. The laser light passing through the spatial light modulator 52 is incident on the cylindrical lens 51 at different positions. The exit angle of exit light exiting from the cylindrical lens 51 varies depending on the positions at which the incident light is incident on the cylindrical lens 51. Accordingly, by changing the aperture positions of the spatial light modulator 52 to change the incidence positions of the laser beams on the cylindrical lens 51 as shown in FIG. 2C, the reference light is applied to the hologram recording medium 40 from plural directions.

### Second Exemplary Embodiment

A hologram recording apparatus according to a second exemplary embodiment of the invention will be described below. In the second exemplary embodiment, an optical element array 70 in which plural optical elements 50 are arranged in the parallax direction is used as the reference light applying unit.

FIGS. 3A and 38 are top views illustrating the configuration of the hologram recording apparatus according to the second exemplary embodiment. In the second exemplary embodiment, illuminating light is applied to an object and the reflected light reflected from the object is recorded as object light on the hologram recording medium 40.

In the second exemplary embodiment, the illuminating light is applied to the object 200. The light reflected from the object 200 is applied to the hologram recording medium 40 via a lens 80. A master hologram as a holographic stereogram may be used instead of the object 200.

On the other hand, the optical element array 70 serving as the reference light applying unit is disposed on the side opposed to the object light with the hologram recording medium 40 interposed therebetween. In the optical element array 70, the optical elements 50 are arranged in the parallax direction in parallel. Laser light emitted from a laser source not shown is incident as reference light on the optical element array 70.

As described in the first exemplary embodiment, the optical elements 50 constituting the optical element array 70 convert the incident reference light into reference light including plural light beams having different optical axes and apply the reference light to the hologram recording medium 40. Since the optical elements 50 of the optical element array 70 are arranged in parallel in the parallax direction, the incidence direction of the reference light passing through the optical element array 70 on the hologram recording medium 40 is periodically changed. That is, the optical element array 70 simultaneously applies the reference light, the incidence direction of which is periodically changed on the hologram recording medium 40, to the recording medium.

The object light condensed on the hologram recording medium 40 by the lens 80 interferes with the reference light simultaneously applied to the hologram recording medium 40 from plural directions and the interference fringes are recorded on the hologram recording medium 40.

FIG. 3B is a perspective view illustrating an example where a hologram is recorded on the hologram recording medium 40 by the use of the optical element array 70. As shown in FIG. 3B, the reference light incident on the optical element array 70 is converted into the reference light to simultaneously be applied to the hologram recording medium 40 while the incidence direction on the hologram recording medium is periodically changed. The reference light applied from plural directions interferes with the object light and plural parallax images are simultaneously recorded on the hologram recording medium 40. In FIGS. 3A and 3B, the images recorded on the hologram recording medium 40 by the object light reflected from the object 200 are set as parallax images [1] to [4] and the parallax images [1] to [4] recorded depending on the incidence directions of the reference light are set as the element holograms 1a to 4c. In the second exemplary embodiment, the element holograms 1a to 4c are simultaneously recorded on the hologram recording medium.

According to the second exemplary embodiment, parallax images [1] to [4] are simultaneously recorded on the hologram recording medium 40 and the parallax images are recorded using the reference light having different incidence directions. Accordingly, it is possible to create a hologram without missing information of the object light. It is also possible to further shorten the hologram creation time and to create a hologram alleviating the conditions regarding the illuminating light used to reproduce the hologram.

### Third Exemplary Embodiment

A hologram recording apparatus according to a third exemplary embodiment of the invention will be described below. In the third exemplary embodiment, an optical element array 70′ in which plural optical elements 50 are arranged at positions shifted in the direction perpendicular to the parallax direction is used as the reference light applying unit.

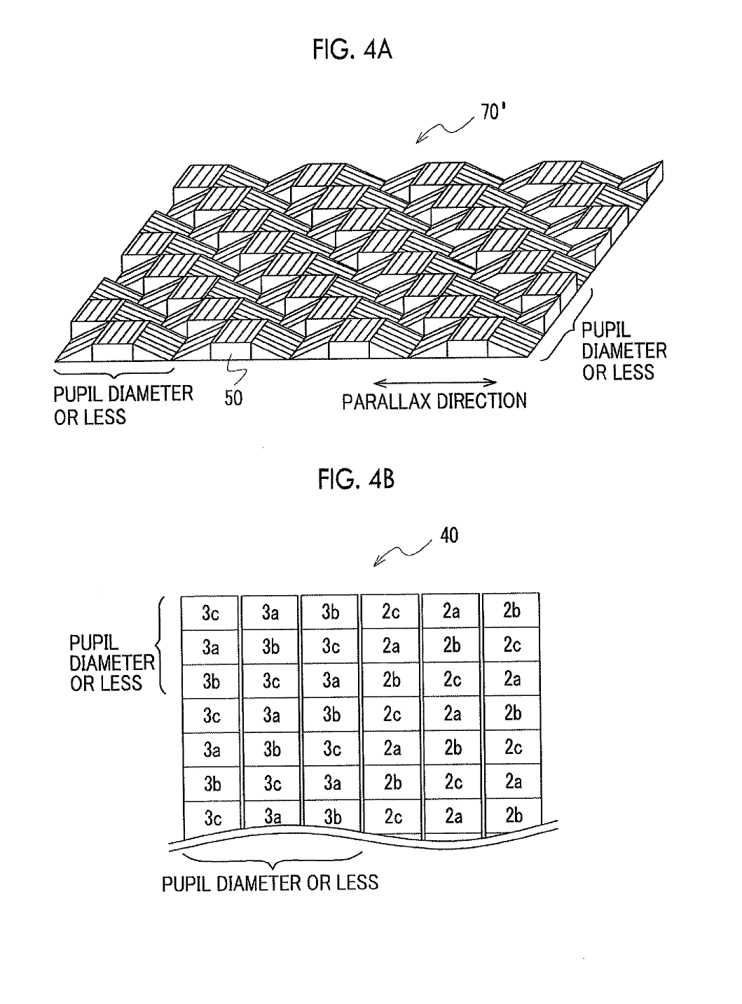

FIG. 4A shows an example of the optical element array 70′ used in the third exemplary embodiment of the invention. As shown in FIG. 4A, the optical element array 70′ serving as the reference light applying unit has a configuration in which the optical elements 50 are arranged at positions shifted in the direction perpendicular to the parallax direction with a change in width in the perpendicular direction of the optical elements 50. By arranging the optical elements 50 at the positions shifted in the direction perpendicular to the parallax direction, the incidence direction of the reference lights on the hologram recording medium 40 is periodically changed in the direction perpendicular to the parallax direction.

FIG. 4B shows an example of an image recorded on the hologram recording medium when a hologram is recorded using the optical element array 70′ shown in FIG. 4A. As shown in FIG. 4B, parallax images are recorded on the hologram recording medium 40 using the reference light of which the incidence direction is periodically changed in the parallax direction and the direction perpendicular to the parallax direction. Accordingly, even when plural light sources illuminating a hologram are present, such as in a room, or when the illumination direction on the hologram is frequently changed (such as in a vehicle vibrating or during walking), the reproducing conditions may be easily satisfied and the position of the hologram satisfying the reproducing conditions extends uniformly over the entire image (in the parallax direction and the direction perpendicular thereto). Accordingly, the uneven intensity of a reproduced image is suppressed. In FIG. 4B, “3a” represents parallax image [3] recorded on the hologram recording medium 40 using the reference light incident from the a direction and “3b” represents parallax image [3] recorded on the hologram recording medium 40 using the reference light incident from the b direction. In addition, “3c” represents parallax image [3] recorded on the hologram recording medium 40 using the reference light incident from the c direction.

In the third exemplary embodiment, it is preferable that the one-cycle width is equal to or less than the pupil diameter. That is, it is preferable that the width of an image recorded using the reference light included within one cycle in the parallax direction and the direction perpendicular thereto is equal to or less than the pupil diameter (about 3 mm). This is implemented by adjusting the width in the direction perpendicular to the parallax direction of the optical elements 50 constituting the optical element array 70′. Specifically, the width in the direction perpendicular to the parallax direction of each optical element 50 may be set to be equal to or less than (pupil diameter/number of incidence directions of reference light included within one cycle). For example, when the number of incidence directions of the reference light included within one cycle is 3, about 1 mm which is calculated by (pupil diameter (about 3 mm)/3) may be set as the width in the perpendicular of each optical element 50. Accordingly, it is possible to suppress a reproduced stereoscopic image from giving a sense of discontinuity to an observer in the direction perpendicular to the parallax direction.

As the method of creating a holographic stereogram, a one-step method and a two-step method are known (for example, see “Contact with Optical Technology”, Vol. 28, No. 8, 459-465 (1990), written by Yasunori. Hiroshi and Honda Toshio). A master hologram is not necessary in the one-step method, but is necessary in the two-step method. The first exemplary embodiment may be preferably applied to the one-step method and the second exemplary embodiment may be preferably applied to the two-step method.

The above-mentioned exemplary embodiments are partial examples of the invention. The invention is not limited to the exemplary embodiments, but may be modified in various forms without departing from the concept of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A hologram recording apparatus comprising:
a reference light applying unit that includes an incidence plane, that converts reference light incident on the incidence plane into reference beams to be incident on a recording medium from a plurality of directions, and that simultaneously applies the reference beams to the recording medium; and
an object light applying unit that applies object light, in which a plurality of identical parallax images are arranged to correspond to the neighboring reference beams having different incidence angles, to the recording medium.

2. The hologram recording apparatus according to claim 1, wherein
the reference light applying unit includes an optical element that converts the reference light incident on the incidence plane into the reference beams to be incident on the recording medium from the plurality of directions and periodically changes the incidence direction of the reference beams on the recording medium, and
the reference beams are applied to the entire area of the recording medium to which the object light is applied.

3. The hologram recording apparatus according to claim 1, wherein
the total width of the same parallax image is equal to or less than a pupil diameter.

4. The hologram recording apparatus according to claim 2, wherein
the total width of the same parallax image is equal to or less than a pupil diameter.

5. The hologram recording apparatus according to claim 1, wherein
the reference light applying unit changes the incidence directions of the reference beams on the recording medium in two different directions.

6. The hologram recording apparatus according to claim 2, wherein
the reference light applying unit changes the incidence directions of the reference beams on the recording medium in two different directions.

7. The hologram recording apparatus according to claim 3, wherein
the reference light applying unit changes the incidence directions of the reference beams on the recording medium in two different directions.

8. The hologram recording apparatus according to claim 4, wherein
the reference light applying unit changes the incidence directions of the reference beams on the recording medium in two different directions.

9. The hologram recording apparatus according to claim 5, wherein
the reference light applying unit periodically changes the incidence directions of the reference beams on the recording medium in the two different directions, and
a one-cycle width is equal to or less than a pupil diameter.

10. The hologram recording apparatus according to claim 6, wherein
the reference light applying unit periodically changes the incidence directions of the reference beams on the recording medium in the two different directions, and
a one-cycle width is equal to or less than a pupil diameter.

11. The hologram recording apparatus according to claim 7, wherein
the reference light applying unit periodically changes the incidence directions of the reference beams on the recording medium in the two different directions, and
a one-cycle width is equal to or less than a pupil diameter.

12. The hologram recording apparatus according to claim 8, wherein
the reference light applying unit periodically changes the incidence directions of the reference beams on the recording medium in the two different directions, and
a one-cycle width is equal to or less than a pupil diameter.
